(19) United States
(12) Patent Application Publication
(10) Pub. No.: US 2015/0049952 A1
(43) Pub. Date: Feb. 19, 2015

(54) SYSTEMS AND METHODS OF MEASURING FACIAL CHARACTERISTICS

(71) Applicant: VSP LABS, INC., Rancho Cordova, CA (US)

(72) Inventors: SAMEER CHOLAYIL, FORT WORTH, TX (US); BRIAN HUNG DOAN, CARROLLTON, TX (US); PHUONG THI XUAN PHAM, IRVING, TX (US)

(73) Assignee: VSP LABS, INC., RANCHO CORDOVA, CA (US)

(21) Appl. No.: 13/967,079

(22) Filed: Aug. 14, 2013

(51) Int. Cl. G06K 9/00

(52) U.S. Cl. CPC G06K 9/00248
USPC 382/195

(57) ABSTRACT

Systems and methods for measuring facial characteristics of patients. In various embodiments, the system uses a geometric pattern to determine a reference scale for an image that includes the geometric pattern and at least a portion of the patient's face. The system may determine the reference scale based at least in part on a known measurement within the geometric pattern. The known measurement may include a distance between two geometric attributes of the geometric pattern. The system may be further configured to correct for errors caused by an orientation of the geometric pattern within the image and/or distortion of the geometric pattern within the image. The geometric pattern may be disposed on a reference device that may be configured to enable a user to attach the reference device to the head of the patient or a pair of eyewear worn by the patient.

### BACKGROUND

When fitting eyewear for a user, it may be necessary to take measurements of various facial characteristics of the user. Accordingly, there is a need for improved methods and techniques for taking such measurements.

### SUMMARY

A reference device for facilitating measurement of one or more facial characteristics of a user, according to various embodiments, comprises a geometric pattern and an attachment mechanism operatively coupled to the geometric pattern. In a particular embodiment, the geometric pattern comprises a first geometric attribute and a second geometric attribute spaced a first distance apart from the first geometric attribute. In some embodiments, the attachment mechanism is configured to removably attach the geometric pattern to an object selected from a group consisting of: (i) an eyewear frame; and (ii) the user's head.

A computer system for measuring facial characteristics of a person wearing eyewear, according to various embodiments, comprises at least one processor. In particular embodiments, the computer system is configured for receiving a first image that comprises a reference device and at least a portion of the face of a wearer of eyewear that includes at least the wearer's first and second eye. In various embodiments, the reference device has a geometric pattern and is attached to the pair of eyewear worn by the wearer, and the geometric pattern includes a first geometric attribute and a second geometric attribute spaced a known distance apart from the first attribute. In various embodiments, the system is further configured to determine a distance between the first geometric attribute and the second geometric attribute from the image; calculate, based at least in part on the known distance and the determined distance, a reference scale for the first image; determine a measurement of a facial characteristic from the first image; and using the reference scale and the measurement of the facial characteristic, calculate an actual measurement of the facial characteristic of the wearer in the first image.

A method of measuring a facial characteristic of a patient, in various embodiments, comprises providing a reference device, where the reference device comprises a geometric pattern having a first geometric attribute and a second geometric attribute spaced apart from the from the first geometric attribute. The reference device also comprises an attachment mechanism operatively coupled to the geometric pattern and configured to enable a user to selectively attach the reference device to eyewear. In particular embodiments, the method further includes: (1) attaching the reference device to eyewear; (2) placing the pair of eyewear and the reference device on a patient; (3) receiving, by at least one processor, an image comprising the reference device and at least a portion of the patient's face; (4) determining, by at least one processor, a measurement of a second distance between the first geometric attribute and the second geometric attribute from the received image; (5) calculating, by at least one processor, a reference scale for the image based at least in part on the first distance and the second distance; and (6) using, by at least one processor, the reference scale to convert measurements of facial characteristics of the patient taken from the image into actual measurements of the patient's facial characteristics.

### BRIEF DESCRIPTION OF THE DRAWINGS

Various embodiments of a system and method for measuring facial characteristics of a user are described below. In the course of this description, reference will be made to the accompanying drawings, which are not necessarily drawn to scale, and wherein:

FIG. 1 is a perspective view of a reference device according to a particular embodiment of the present system and methods;

FIG. 2 is a detail view of a geometric pattern according to a particular embodiment;

FIG. 3A is a front perspective view of the reference device of FIG. 1;

FIG. 3B is a rear perspective view of the reference device of FIG. 1;

FIG. 3C is an exploded view of the reference device of FIG. 1;

FIG. 4 is a block diagram of a facial characteristic measuring system in accordance with an embodiment of the present system;

FIG. 5 is a schematic diagram of a computer, such as a mobile measuring device that may be suitable for use in various embodiments;

FIG. 6 depicts a flow chart that generally illustrates steps performed by a facial characteristic measuring module.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Reference Device

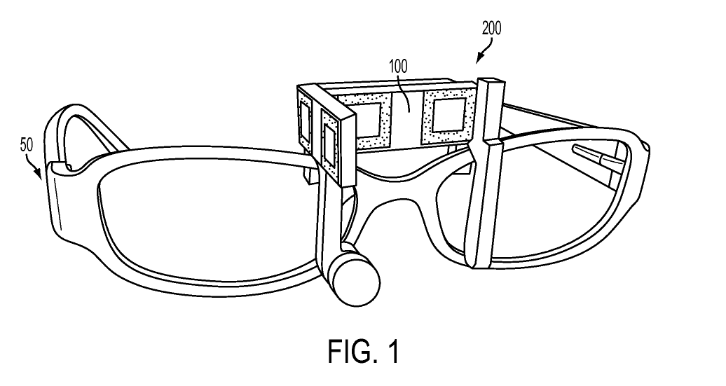

Referring to FIG. 1, a reference device for measuring various facial characteristics, in various embodiments, comprises a geometric pattern 100 and a geometric pattern mounting device 200. The geometric pattern mounting device 200 removably couples the geometric pattern 100 to a pair of eyewear 50 according to a particular embodiment. These and other components of a reference device for measuring various facial characteristics are discussed more fully below.

### Geometric Pattern

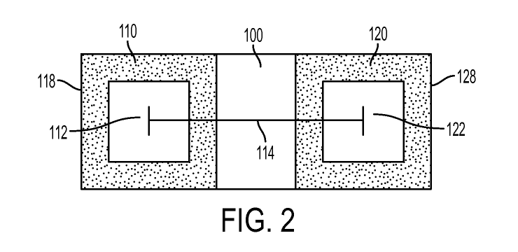

FIG. 2 shows an exemplary geometric pattern 100 for use with a reference device for measuring various facial characteristics. In the embodiment shown in this figure, the geometric pattern 100 is substantially symmetrical (e.g., symmetrical) and comprises a first geometric attribute 110 and a second geometric attribute 120. In this embodiment, the first and second geometric attributes 110, 120 each comprise a substantially rectangular (e.g., substantially square) polygon that are spaced a first distance apart from one another. In the embodiment shown in this figure, the square geometric attributes 110, 120 are substantially the same size, are coplanar, and oriented so that a side of each rectangular polygon is substantially parallel to one another. In particular embodiments, the first and second geometric attributes 110, 120 are substantially identical. In various embodiments, the first distance is a distance 114 between the centers of the substantially square geometric attributes 110, 120.

In various embodiments, each side of the two square geometric attributes 110, 120 has a length of between about 3 millimeters and about 15 millimeters. In a particular embodiment, each side of the two square geometric attributes 110, 120 has a length of about 5 millimeters. In yet another particular embodiment, each side of the two square geometric attributes 110, 120 has a length of about 10 millimeters. In various embodiments, the first distance is between about 10 millimeters and about 25 millimeters. In a particular embodiment, the first distance is about 16 millimeters.

In the embodiment shown in FIG. 2, the first and second geometric attributes 110, 120 have a perimeter edge 118, 128 formed in a first color and a corresponding interior surface 112, 122 at least partially bounded (e.g., fully bounded) by the perimeter edge 118, 128 in a second color. In particular embodiments, the interior surface 112, 122 may be partially bounded by the perimeter edge 118, 128 (e.g., the interior surface 112, 122 may not be fully bounded by the perimeter edge 118, 128). In various embodiments, the first and second colors are sufficiently contrasting to enable an imaging device to at least substantially distinguish between the perimeter edge and the interior surface (e.g., transition from the first color to the second color). In the embodiment shown in this figure, the perimeter edge is a dark color (e.g., black) and the interior portion is a lighter color (e.g., white). In other embodiments, the perimeter edge and interior portions may comprise any suitable color combination that is sufficiently contrasting (e.g., black and orange, black and yellow, red and green, etc.). Moreover, particular finishes on the geometric pattern can enhance or decrease the system's ability to distinguish between the perimeter edge area and the interior surface area. For example, in various embodiments, a matt finish on the geometric pattern may increase the system's ability to detect a transition from the perimeter edge to the interior area in various lighting conditions.

In various embodiments, the perimeter edge 118, 128 is sufficiently thick to enable an imaging device to detect a transition from the perimeter edge 118, 128 to the interior surface 112, 122. For example, in a particular embodiment, the perimeter edge 118, 128 is sufficiently thick such that an image of the geometric pattern 100 taken by an imaging device from a reasonable distance (e.g., such as a distance from which an image would be taken of a patient by a person desiring to take a measurement of a facial characteristic of the patient) would include the perimeter edge 118, 128, and the perimeter edge 118, 128 would have a thickness of two or more pixels within the image. In some embodiments, the thickness of the perimeter edge 118, 128 is between about 1 mm and about 4 mm thick. In a particular embodiment, the thickness of the perimeter edge 118, 128 is about 2 mm.

In other embodiments, the first and second geometric attributes 110, 120 may include any other suitable geometric attribute. For example, in a particular embodiment, the first and second geometric attributes 110, 120 may include any suitable portions of a geometric pattern 100. For example, a geometric pattern comprising a single substantially rectangular polygon may include first and second geometric attributes 110, 120 in the form of opposing edges of the substantially rectangular polygon. In other embodiments the first and second geometric attributes 110, 120 may have any other suitable shape than rectangular such as circular or polygonal (e.g., triangular, pentagonal, hexagonal, heptagonal, octagonal, or any other suitable polygon).

In various embodiments, the first and second geometric attributes may comprise any suitable portion of a geometric pattern that enables an imaging device to measure a distance between the first and second geometric attributes from a digital image that contains the first and the second geometric attributes. The geometric attributes may comprise, for example any suitable portion of a geometric shape that makes up part of the geometric pattern (e.g., an edge, a center, etc.). In various embodiments, the geometric pattern may include any suitable combination of shapes having defined angles (e.g., such as any suitable combination of polygons). It should be understood that geometric patterns that contain known angles are preferred over geometric shapes without angles. Thus, geometric patterns containing 90 degree inside angles enhances detection of the geometric pattern while reducing the incidence of false detection of unintended patters in the image.

### Geometric Pattern Mounting Device

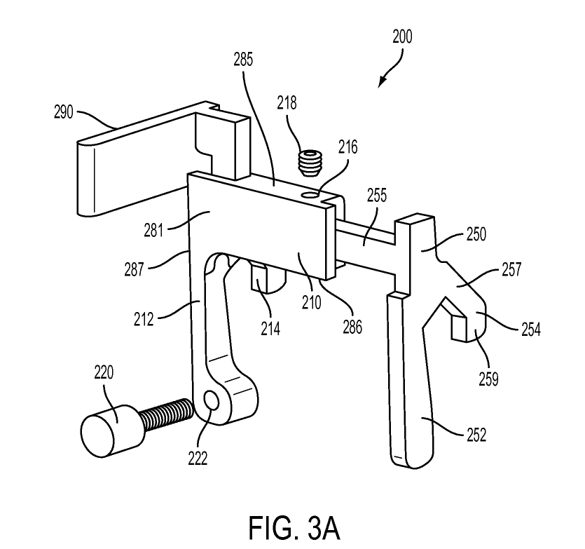

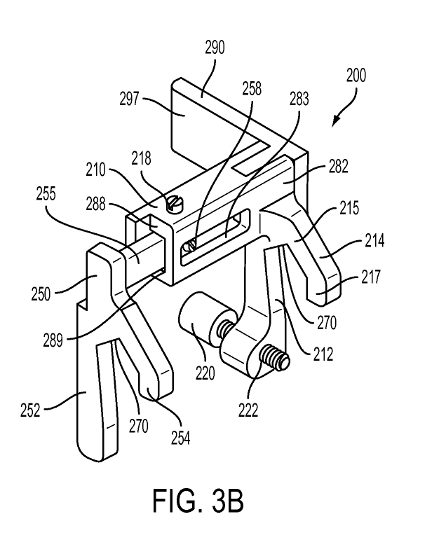

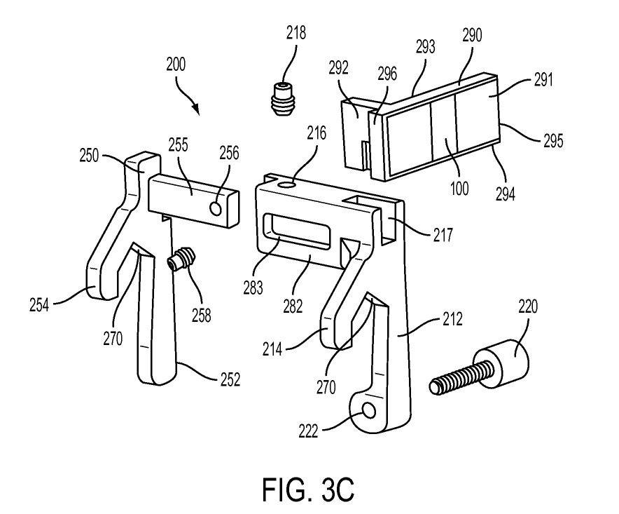

FIGS. 3A-3C show an exemplary geometric pattern mounting device 200. As may be understood from FIGS. 3A-3C and from FIG. 1, the geometric pattern mounting device 200, in various embodiments, is configured to enable a user to selectively attach the geometric pattern 100 to a pair of eyewear 50. In the embodiment shown in FIGS. 3A-3C, the geometric pattern mounting device 200 comprises a clip body 210, a clip horizontal slider 250, and a vertex reference mount 290. These features are discussed more fully below.

Clip Body

Referring particularly to FIGS. 3A and 3B, in the embodiment shown the clip body 210 is substantially rectangular (e.g., rectangular); extends between a first end side wall 287 and a second end side wall 288; and has a substantially flat (e.g., flat) front surface 281, a rear surface 282, a top surface 285 and a bottom surface 286. As may be understood from FIG. 3B, the clip body 210 defines a substantially rectangular first opening 289 that is formed through the second end side wall 288, extends at least partially between the second end side wall 288 and the first end side wall 287, and opens into a substantially rectangular chamber within the clip body 210 defined by the front surface 281, rear surface 282, top surface 285 and bottom surface 286. The clip body 210 further defines a substantially rectangular rear cutaway 283 on the clip body's rear surface 282 that opens into the rectangular chamber. The clip body 210, in particular embodiments, further defines a first threaded opening 216 formed in top surface 285 of the clip body 210. In various embodiments, the clip body 210 defines a vertex reference mount support notch 217 (FIG. 3C) formed through the clip body's top surface 285 adjacent the first end side wall 288.

In particular embodiments, the clip body 210 comprises a first frame support 212 that extends substantially perpendicularly from the clip body bottom surface 286 and a second frame support 214 (FIG. 3B) that extends from the clip body rear surface 282. The second frame support has a first proximate portion 215 that is disposed at an angle with respect to the first frame support 212, and a second distal portion 217 that is substantially parallel to the first frame support 212. In various embodiments, the first and second frame supports 212, 214 are configured to cooperate to maintain the geometric pattern mounting device 200 adjacent a pair of eyewear (e.g., adjacent a top surface of the eyewear frame such that the geometric pattern 100 is positioned substantially above the eyewear when the eyewear is being worn by a user). In a particular embodiment, the first and second frame supports 212, 214 form a cradle 270 that is configured to receive at least a portion of the frame of the eyewear (e.g., the top of the frame). In other embodiments, the geometric pattern mounting device 200 may include any other suitable mechanism for attaching the geometric pattern mounting device 200 to a pair of eyewear (e.g., such as a clip, sticker, magnet, etc.).

In the embodiment shown in FIGS. 3A-3B, the clip body's first frame support 212 contains a second threaded opening 222 that is sized to receive a threaded screw 220. As may be understood from these figures and from FIG. 1, the threaded screw 220 is configured to adjust a pitch of the front surface 281 of the clip body 210 relative to the eyewear 50 when the geometric pattern mounting device 200 is attached to the eyewear 50. In this embodiment, the threaded screw is configured to enable a user to move the threaded screw 220 relative to the second threaded opening 222 in order to adjust the pitch of the front surface 281 of the clip body 210. Said another way, as the length of the threaded screw 220 increases in length through the back side of the first frame support 212, it engages a front surface of a lens in the frame thereby causing the mounting device to rotate rearward thereby changing the pitch angle of the front surface 281 of the clip body front face 281.

In other embodiments, the geometric pattern mounting device 200 may include any other suitable mechanism for adjusting the pitch of the front surface 281 of the clip body 210 relative to the eyewear 50 when the geometric pattern mounting device 200 is attached to the eyewear 50. For example, the front surface 281 may be defined on a second portion (not shown) of the clip body 210 that is adjustably coupled to the clip body (e.g., via a swivel, hinge, or other mechanism suitable for adjusting a pitch of the front surface 281 relative to the clip body 210).

As shown in FIG. 3A, the front surface 281 of the clip body 210 is substantially flat and is configured to receive the geometric pattern 100 thereon (e.g., such as in the embodiment shown in FIG. 1). As may be understood from FIG. 1, the substantially flat front surface 281 is defined such that when the geometric pattern mounting device 200 is attached to the eyewear 50, the substantially flat front surface 281 is positioned facing substantially away from the wearer of the eyewear (e.g., in a position such that the geometric pattern 100 would be substantially facing an imaging device taking an image of a wearer's face while the wearer was wearing eyewear with the geometric pattern attached).

Clip Horizontal Slider

As shown in FIG. 3C, the clip horizontal slider 250 comprises a substantially rectangular (e.g., rectangular) sliding portion 255, a first frame support 252 that extends from an end of sliding portion 255, and is substantially perpendicularly to the sliding portion 255. A second frame support 254 has a first proximate portion 257 (FIG. 3A) that is disposed at an angle from the first frame support 252, and a second distal portion 259 (FIG. 3A) that is substantially parallel to the first frame support 252. As may be understood from these figures, the first and second frame supports 252, 254 generally form an end portion of the sliding portion 255. In various embodiments, the sliding portion 255 is configured to slide within the chamber formed in the clip body 210 through the clip body's first opening 289 to enable a user to adjust a length of the geometric pattern mounting device 200 to accommodate for different size frames. As may be understood from FIG. 3B, when the sliding portion 255 is at least partially inserted into the clip body 210, the clip body 210 and the clip horizontal slider 250 form a substantially rigid structure.

In particular embodiments, the clip horizontal slider 250 is configured to utilize a locking screw 218 that generally corresponds in size to the first threaded opening 216. The interaction of the locking screw 218 and the sliding portion 255 enables a user to tighten the locking screw 218 against the sliding portion 255 to at least substantially lock a position of the clip horizontal slider 250 relative to the clip body 210. As shown in FIG. 3C, the sliding portion 255 defines a substantially circular third threaded opening 256 that is configured to receive a second locking screw 258 that is configured to enable a user to tighten the second locking screw 258 against an inside wall of the clip body to at least substantially prevent the clip horizontal slider 250 from moving relative to the clip body 210.

In other embodiments, the geometric pattern mounting device 200 may include any other suitable mechanism for adjusting a size of the geometric pattern mounting device 200 (e.g., a length of the geometric pattern mounting device 200). For example, the clip body 210 may define one or more circular recesses along a surface defining the cavity, and the sliding portion 255 may comprise a spring loaded ball detent that is configured to cooperate with any one of the plurality of recesses to maintain a position of the clip horizontal slider relative to the clip body, while enabling a user to substantially easily adjust the position by applying sufficient force to the clip horizontal slider to force the ball up against the spring allowing the ball to move from one recess to an adjacent recess.

In another example, the clip body 210 may comprise a first portion and a second portion that are configured to enable a user to selectively couple the first portion to the second portion. In this example, the geometric pattern mounting device 200 may further comprise one or more spacers that are configured to enable a user to adjust a size of the geometric pattern mounting device 200 by for example: (1) decoupling the clip body first portion from the clip body second portion; (2) coupling one or more spacers to the clip body first portion; and (3) coupling the clip body second portion to the one or more spacers coupled to the clip body first portion. As may be understood from this example, coupling the first and second portions via the one or more spacers may increase the overall length of the geometric pattern mounting device 200 by the length of the one or more spacers. The spacers may include spacers in any size suitable for increasing the length of the geometric pattern mounting device 200 by any suitable increment.

In various embodiments, the mechanism for adjusting the size of the geometric pattern mounting device 200 may enable a user to adjust the geometric pattern mounting device 200 in order to use the geometric pattern mounting device 200 in combination with eyewear of substantially any size or shape (e.g., enable the user to selectively mount the geometric pattern mounting device 200 to substantially any pair of eyewear).

Vertex Reference Mount

Referring to FIG. 3C, in various embodiments, the vertex reference mount 290 is substantially rectangular (e.g., rectangular); extends between a first end side wall 295 and a second end side wall 296; and has a substantially flat (e.g., flat) front surface 291, a rear surface 297 (FIG. 3B), a top surface 293 and a bottom surface 294. In various embodiments, the vertex reference mount 290 comprises a mounting arm 292 that extends substantially perpendicularly from the rear surface 297 and is sized to substantially correspond to the vertex reference mount support notch 217 defined in the clip body 210. As may be understood from the figures, the vertex reference mount 290 is configured to selectively attach to the clip body 210 by at least partially inserting the mounting arm 292 into the support notch 217. In this embodiment, when the vertex reference mount 290 is attached to the clip body 210, the front surface 291 is substantially perpendicular to the clip body's front surface 281. As shown in these figures, the front surface 291 may, for example, comprise a second geometric pattern 100. In various embodiments the vertex reference mount 290 may provide a geometric pattern in a plane perpendicular to a primary geometric plane, and the vertex reference mount 290 may enable measurement of particular geometric features of a user's face (e.g., such as vertex distance or pantoscopic tilt).

### Overview of a System for Measuring Facial Characteristics

In various embodiments, a system for measuring facial characteristics is configured to measure pupillary distance (e.g., a distance between a person's pupils), vertex distance (e.g., a distance between a back surface of a corrective lens and the front of a cornea of a wearer of the corrective lens), or any other suitable characteristic of a person's face. In particular embodiments, the system is configured to determine these various facial measurements by: (1) receiving an image containing the person's face and one or more of the geometric pattern's described above; (2) determining a reference scale for the image based at least in part on the geometric pattern as measured in the image and compared to the known size and shape of the geometric pattern; and (3) determining the facial measurement based at least in part on the reference scale.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

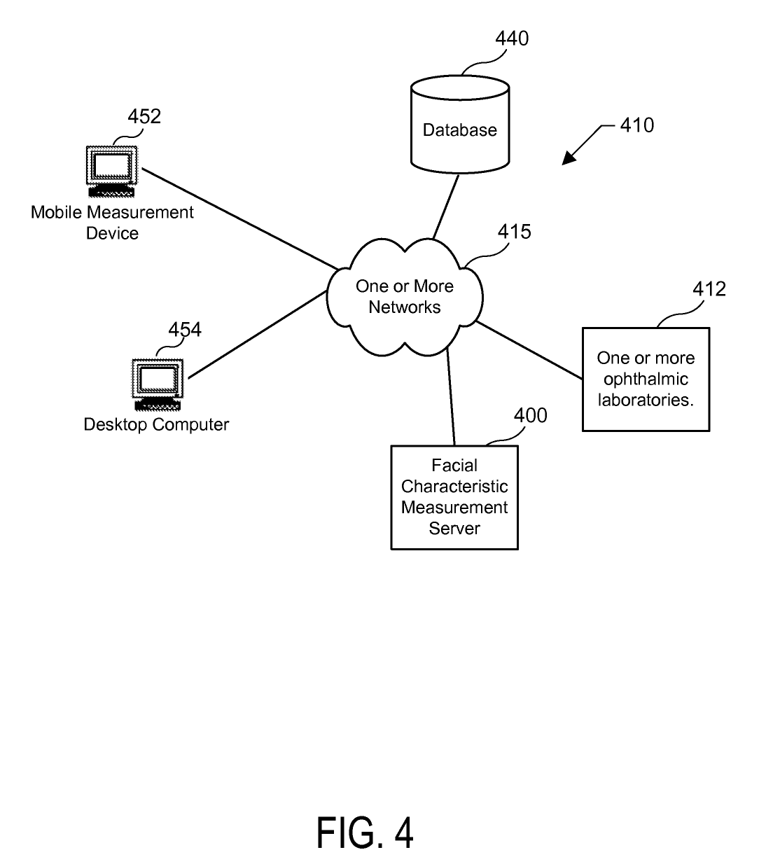

An overview of the digital measurement system for optical applications according to an illustrative embodiment is described with reference to FIG. 4. As illustrated in FIG. 4, the system 410 includes at least one mobile measurement device 452 (e.g., such as a smart phone, a tablet computer, a wearable computing device, a laptop computer, etc.) configured to receive or collect data of, or from, at least one user, which may be a patient or an eye care professional (ECP) (e.g., an optometrist, an optician, an assistant, or other eye care technician). The mobile measurement device 452 includes an optical system and image acquisition technology. The optical system and image acquisition technology may be one or more digital cameras or digital video recorders capable of collecting one or more images, videos, or taking one or more photographs.

In an illustrative embodiment, the mobile measurement device 452 communicates with, accesses, receives data from, and transmits data to a Facial Characteristic Measurement Server 400 via one or more networks 415. In general, the Facial Characteristic Measurement Server 400 provides computing/processing resources, software, data access, and storage resources without requiring the user or client to be familiar with the location and other details of the Facial Characteristic Measurement Server 400. The Facial Characteristic Measurement Server 400 includes one or more modules accessible by the mobile measurement device 452, including a facial characteristic measuring module 600 (described in more detail below) and one or more associated databases 440. In an illustrative embodiment, the mobile measurement device 452 may communicate with one or more ophthalmic laboratories 412 via the one or more networks 415 to submit orders to the one or more ophthalmic laboratories 412 for frames and/or lenses.

In an illustrative embodiment, the mobile measurement device 452 accesses the facial characteristic measuring module 600 allowing accurate position of wear measurements of a patient to be obtained based on one or more images of the patient. The mobile measurement device 452 can be used to obtain, for example, monocular pupillary distance (PD), binocular PD, monocular near PD, binocular near PD, vertex distance, and other measurements of the type. These measurements may then be sent to and used, for example, by one or more ophthalmic laboratories to produce customized lenses for the patient.

System 410 may also include a desktop computer 454 that is operatively coupled to the database 440 and facial characteristic measurement server 400 via the one or more networks 415. Desktop computer 454 may be used to run practice management software where additional information or facial characteristic measurements may be received and stored. In various embodiments, the facial characteristic measurements, image of the patient, etc. may be used by the desktop computer 454 to display the data or allow the ECP to illustrate how various eyewear frames would look on the patient.

The one or more computer networks 415 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between Facial Characteristic Measurement Server 400 and Database 440 may be, for example, implemented via a Local Area Network (LAN) or via the Internet.

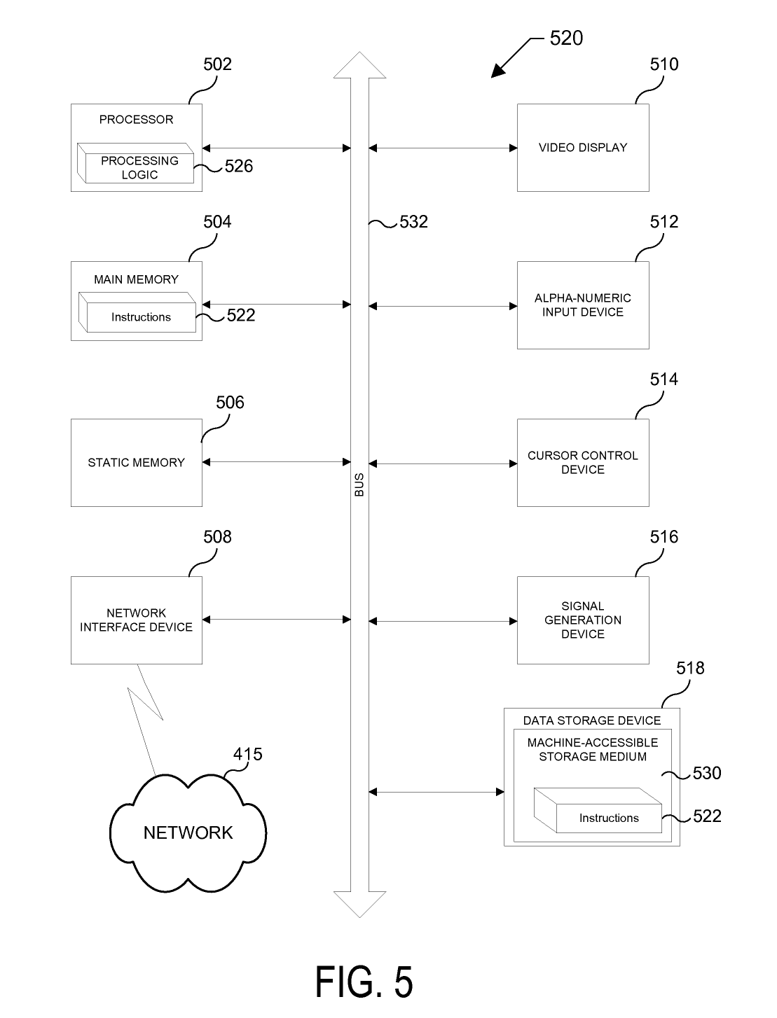

FIG. 5 illustrates a diagrammatic representation of a computer architecture 520 that can be used within the System 410, for example, as one of mobile measurement device 452, desktop computer 454, or as Facial Characteristic Measurement Server 400, as shown in FIG. 4.

In particular embodiments, the computer 520 may be connected (e.g., networked) to other computers in a LAN, an intranet, an extranet, and/or the Internet. As noted above, the computer 520 may operate in the capacity of a server or a client computer in a client-server network environment, or as a peer computer in a peer-to-peer (or distributed) network environment. Further, while only a single computer is illustrated, the term “computer,” “processor” or “server” shall also be taken to include any collection of computers that individually or jointly execute a set (or multiple sets) of instructions to perform any one or more of the methodologies discussed herein.

An exemplary computer 520 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 532.

The processor 502 represents one or more general-purpose processing devices such as a microprocessor, a central processing unit, or the like. More particularly, the processor 502 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 may be configured to execute processing logic 526 for performing various operations and steps discussed herein (e.g., facial characteristic measuring module 600).

The computer 520 may further include a network interface device 508. The computer 520 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a non-transitory computer-accessible storage medium 530 (also known as a non-transitory computer-readable storage medium or a non-transitory computer-readable medium) on which is stored one or more sets of instructions (e.g., software 522 in the form of facial characteristic measuring module 600) embodying any one or more of the methodologies or functions described herein. The software 522 may also reside, completely or at least partially, within the main memory 504 and/or within the processor 502 during execution thereof by the computer 520—the main memory 504 and the processor 502 also constituting computer-accessible storage media. The software 522 may further be transmitted or received over the network 415 via a network interface device 508.

While the computer-accessible storage medium 530 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Exemplary Methods for Measuring Facial Characteristics

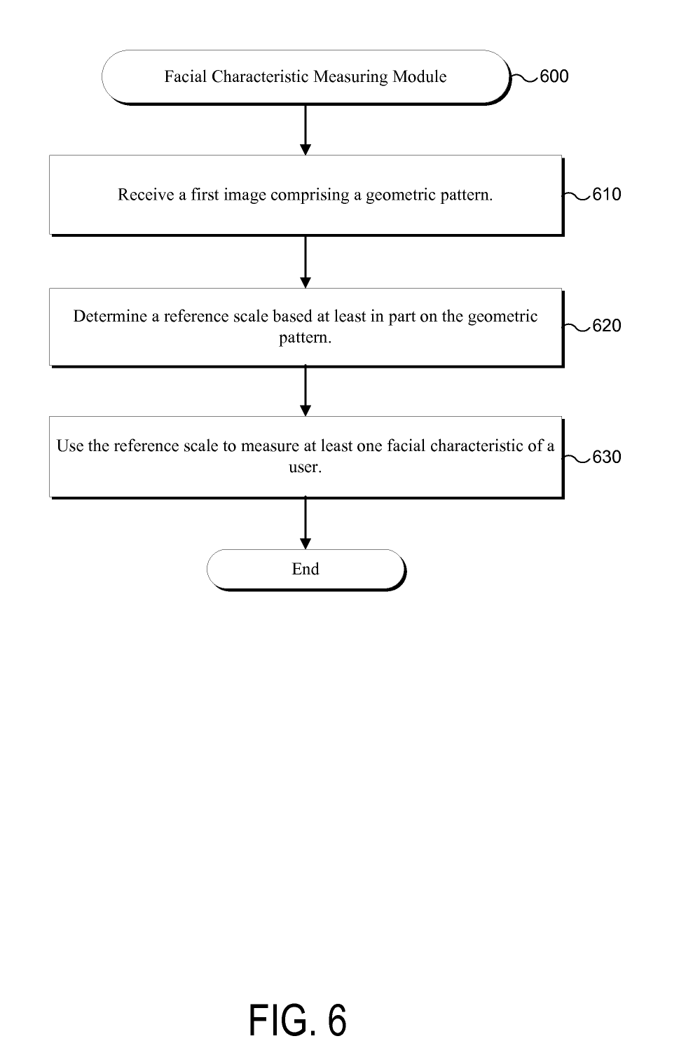

Various embodiments of a method for measuring facial characteristics may be implemented in any suitable manner. For example, various aspects of the system's functionality may be executed by certain system modules, including a Facial Characteristic Measuring Module 600. This module is discussed in greater detail below with reference to FIG. 6. It should be understood by reference to this disclosure that the method associated with the module 600 describes an exemplary embodiment of the methods steps carried out by the present system, and that other exemplary embodiments may be created by adding other steps, by removing one or more of the method steps described in FIG. 6, or by performing one or more of the method steps described in FIG. 6 in an order other than the order in which they are presented.

Overview

A method of using the mobile measurement device 452 according to an illustrative embodiment is described. An ECP accesses the facial characteristic measurement module 600 via the mobile measurement device 452. In an illustrative embodiment, the mobile measurement device 452 is configured to capture an image of the patient when the patient is wearing eyewear frames having the geometric pattern 100 removably attached to the eyewear frames using the geometric pattern mounting device 200 described above.

The ECP positions a patient wearing a selected frame or an object, having the geometric pattern 100 mounted thereon using the geometric pattern mounting device 200 in the field of view of the digital camera in the mobile measurement device 452. The ECP then captures one or more images of the patient or object on the mobile measurement device 452, for example, on a screen or display on the client measurement device 452. The captured image may be stored, for example, in a memory of the mobile measurement device 452 and/or in the one or more databases 440. In an illustrative embodiment, the ECP presses or touches a button on the mobile measurement device 452 to activate the digital camera contained therein and captures the image(s) of the patient or object.

Facial Characteristic Measuring Module

FIG. 6 is a flow chart of operations performed by an exemplary Facial Characteristic Measuring Module 600. In particular embodiments, the Facial Characteristic Measuring Module 600 may facilitate the measurement of a facial characteristic of a user (e.g., such as a patient being fitted for glasses).

When executing the Facial Characteristic Measuring Module 600, the system begins, at Step 610 by receiving a first image comprising a geometric pattern. In various embodiments, the geometric pattern may be any suitable geometric pattern, such as any geometric pattern 100 described in this disclosure. In particular embodiments, the first image comprises at least a portion of a user's face (e.g., at least a portion of the user's face that includes a characteristic of the user's face that the user or another desires to measure). In particular embodiments, the geometric pattern in the first image is disposed on a mounting device (e.g., geometric pattern mounting device 200), which may, for example, be attached to eyewear worn by the user. In particular embodiments, the system may receive the first image from any suitable image capturing device (e.g., a desktop computer or any suitable mobile computing device).

In particular embodiments, the system may be configured to substantially automatically detect the geometric pattern within the first image. That is, the system 410 analyzes the captured image and locates the geometric pattern 100 within the captured image. That is, the system 410 locates a center of each of the first and second geometric attributes within the captured image, using known image processing technology and/or algorithms. In an illustrative embodiment, the system 410 locates the center of each of the first and the second geometric attributes by filtering and analyzing the captured image. The filtering process involves a combination of Gaussian blur, custom color channel manipulation, intensity thresholding, and a Suzuki85 algorithm for connected component labeling. The filtering process produces a set of points defining possible locations of the geometric pattern 100. The set of points or shapes is analyzed according to several criteria, such as, but not limited to, shape area, dimensions of the geometric attributes, and the existence of a similar shape within a certain threshold distance from the shape. If the aforementioned shapes meet the above criteria, the shapes are considered to be successful matches.

For example, in various embodiments, the system 410 may use multiple pattern detection methods. For example, in various embodiments, a first group of methods for pattern detection may be used that (1) isolate search areas for a pattern, (2) increase edge definition with minimal distortion, (3) obtains contour in RGB color space, (4) filter the inner most contour, (5) add the contour to the contour list, and (6) repeats the process for additional contours. Once all suspected contours have been processed, the contours and/or contour pairs are filtered out from the contour list if (1) their polygonal angles do not match the expected angles in the geometric pattern, (2) the area of the contour is outside the expected area geometric pattern, (3) the height/width ratio is outside the expected height/width ratio of the geometric pattern, (4) the contour pairs are not within a specified distance of each other's center points, (5) the area ratio between contour pairs is outside a specified ratio of the geometric pattern, and (6) horizontal angle between contour pairs is outside a specified horizontal angle of the geometric pattern.

In these embodiments, if the captured image contains both bad lighting and bad focus and the first group of pattern detection methods fail, the system may be configured to use a second group of methods for pattern detection that (1) isolates search areas for the geometric pattern, (2) adjusts the image contrast to enable the system to better detect the geometric pattern, (3) gets contours in gray scale, (4) adds the contours to the contour list, and then (5) applies the filtering process described above with regard to the first group of pattern detection methods.

Finally, if the system cannot detect the geometric pattern using the first and second groups of pattern detection methods, the system may be configured to apply a third group of pattern detection methods that (1) isolates search areas for the geometric pattern, (2) gets hue saturation value channel process and applies thresholds, (3) gets contours in gray scale, (4) adds the contours to the contour list, and then (5) applies the filtering process described above with regard to the first group of pattern detection methods.

Once the pattern is detected, the system 410 then determines the distance between the first geometric attribute and the second geometric attribute within the captured image. In an illustrative embodiment, the distance between the first geometric attribute and the second geometric attribute created by the geometric pattern 100 within the captured image is determined in terms of pixels. As described above with respect to FIG. 2, the centers of the first and second geometric attributes within the captured image should be equal to the distance 114 (FIG. 2), for example approximately sixteen millimeters apart from one another.

The system continues, at Step 620 by determining a reference scale for the first image based at least in part on the geometric pattern. In various embodiments, a determination of the reference scale may be based in part on known characteristics of the geometric pattern. For example, the system may determine a reference scale based at least in part on a known distance between two geometric attributes of the geometric pattern. The geometric attributes may include any suitable portion of the geometric pattern, such as, for example, a distance between the centers of the two substantially square geometric attributes 110, 120 of the geometric pattern shown in FIG. 2. In other embodiments, the known distance may include any suitable distance between any suitable reference points within the geometric pattern. These reference points may include any suitable portion of geometric attributes that the geometric pattern comprises (e.g., a distance between edges of one or more geometric attributes, a distance between inner border portions of one or more geometric attributes, or any other suitable distance). Continuing the example above, the first distance 114 is compared to the measured distance in pixels between the centers of the first and second attributes. Thus, the system 410 determines a scaling factor for the captured image.

In various embodiments, determining the reference scale further comprises adjusting the reference scale to correct for errors that arise from misalignment of the geometric reference pattern with respect to a plane of the image sensor in the mobile measurement device 452. For example, the system 410 may account for pitch errors (e.g., when the plane of the geometric pattern is rotated about a horizontal axis with respect to the plane of the image sensor), yaw errors (e.g., when the plane of the geometric pattern 100 is rotated about a vertical axis with respect to the plane of the image sensor, and roll errors (e.g., where the plane of the geometric pattern is rotated about an axis that is normal to the face of the geometric pattern with respect to the plane of the sensor). In other embodiments, the system may be configured to also correct the measured reference scale at least in part by correcting for errors caused by changes in one or more of the pitch, roll and yaw angle of the plane of the image sensor used to capture the image with respect to the plane of the geometric pattern. In still other embodiments, the system is configured to correct for changes in origination of both the geometric pattern plane and the image sensor plane.

In particular embodiments, the system is further configured to correct for errors caused by a distance between the geometric pattern and the user's eye. As may be understood from this disclosure, when wearing eyewear on which a reference device containing a geometric pattern is mounted, the geometric pattern will be spaced a distance apart from the wearer's eye. Thus, an error due to this distance depends on the distance from the image sensor to the lens plane and the distance from the lens plane to the wearer's eyes. The system may be configured to utilize any suitable algorithm to compensate for this offset when determining a reference scale, which may for example, be determined based at least in part on an average offset, a distance between the image capturing device and the user when the image is captured, or any other suitable factor.

Returning to Step 630, the system uses the reference scale to measure at least one facial characteristic of the user. The at least one facial characteristic may include pupillary distance (e.g., a distance between a user's pupils), vertex distance (e.g., a distance between a back surface of a corrective lens and the front of a cornea of the user), pantoscopic tilt (panto) measurements of a patient, or any other suitable characteristic of a user's face from one or more captured images. The system may use the reference scale to measure the at least one facial characteristic by measuring the characteristic from the first image (e.g., by determining a measurement as a number of pixels within the first image) and converting the measurement to a distance based on the reference scale (e.g., converting the measured number of pixels to a distance in inches, millimeters or other suitable measurement unit) where the converted measurement at least generally corresponds to an actual measurement of the at least one facial characteristic (e.g., a real-world distance between two points on the user's face).

As an illustrative example, in order to obtain or calculate the monocular PD, which is the distance from each of the patient's pupils (e.g., using light reflected from the cornea) to the center of the patient's nose (e.g., where the center of the frame bridge rests), and the binocular PD, which is the distance between the patient's pupils, the patient should be facing the mobile measurement device 452. The ECB then positions the patient wearing the selected frame, with the patient facing the mobile measurement device 452 in the field of view of the digital camera.

Once the mobile measurement device 452 captures the first image of the patient, the system 410 analyzes the first image, for example using facial recognition and 3-D rendering technology, and determines the size and dimensions of the patient. The system 410 then analyzes the image and determines or calculates the monocular PD and the binocular PD measurements of the patient.

In order to obtain or calculate the vertex distance, which is the distance between the back surface of a lens and the front of the cornea of the patient, and the pantoscopic tilt, which is the angle between the plane of the lens and frame front and the frontal plane of the face, the patient should be facing about ninety degrees away from the mobile measurement device 452. The ECB positions the patient wearing the selected frame, with the patient facing about ninety degrees away from the mobile measurement device 452, in the field of view of the mobile measurement device 452 and captures a second image of the patient. The system 410 analyzes the second image, for example, using facial recognition and 3-D rendering technology, and determines the size and dimensions of the patient's head. The system 410 then analyzes the image and determines or calculates the vertex distance and pantoscopic tilt measurements of the patient wearing the selected frames.

The pantoscopic tilt is determined by determining an angle between a plane of the lens and frame front and a frontal plane of the patient's face. For example, the frontal plane of the patient's face may be vertical, and the plane of the lens and frame front may be slightly tilted, for example, creating a hypotenuse of a right triangle with a height of the right triangle or an adjacent side (Adj.) of the right triangle being the frontal plane of the patient's face. A horizontal distance from the frontal plane of the patient's face to the plane of the lens and frame front creates an opposite side of the right triangle. Thus, the lengths of the hypotenuse and the adjacent side are the respective distances from the opposite side of the right triangle to a point where the frontal plane of the patient's face and the plane of the lens and frame front intersect. The system 410 can determine the length in pixels of each of the sides of the right triangle and then convert these distances to sufficient units (e.g., inches, mm, etc.) using the reference scale.

Once the system calculates the various facial characteristics of interest, the system 410 may be configured to store the measurements in the one or more databases 440 for later retrieval and use. In various embodiments, the measurements may be stored in conjunction with the patient's information.

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. For example, the eyewear described in this embodiment may include any other suitable eyewear, such as, for example, ski or swim goggles, sunglasses, safety goggles or glasses, etc. Therefore, it is to be understood that the invention is not to be limited to the specific embodiments disclosed and that the modifications and other embodiments are intended to be included within the scope of the appended exemplary concepts. Although specific terms are employed herein, they are used in a generic and descriptive sense only and not for the purposes of limitation.

What is claimed is:

1. A reference device for facilitating measurement of one or more facial characteristics of a user comprises:
a. a geometric pattern comprising:
i. a first geometric attribute; and
ii. a second geometric attribute spaced a first distance apart from said first geometric attribute; and
b. an attachment mechanism operatively coupled to said geometric pattern,
wherein said attachment mechanism is configured to removeably attach said geometric pattern to an object selected from a group consisting of:
i. an eyewear frame; and
ii. said user's head.

2. The reference device of claim 1, wherein said pattern is configured to allow an imaging machine to calculate a reference scale for an image captured by the imaging machine based at least in part on said first distance

3. The reference device of claim 2, wherein:
a. said first geometric attribute is a first border of said geometric pattern; and
b. said second geometric attribute is a second border of said geometric pattern that is spaced apart from said first border by said first distance.

4. The reference device of claim 2, wherein said geometric pattern comprises a first geometric pattern and a second geometric pattern, wherein:
a. said first geometric pattern comprises said first geometric attribute;
b. said second geometric pattern comprises said second geometric attribute.

5. The reference device of claim 4, wherein said first and second geometric patterns are substantially rectangular.

6. The reference device of claim 4, wherein:
a. said first geometric pattern comprises a first perimeter edge formed in a first color and a first interior surface in a second color and at least partially bounded by said first perimeter edge; and
b. said second geometric pattern comprises a second perimeter edge formed in said first color and a second interior surface in said second color and at least partially bounded by said second perimeter edge.

7. The reference device of claim 6, wherein said first and second colors are sufficiently contrasting to enable an imaging device to detect a transition from said first color to said second color.

8. The reference device of claim 4, wherein said first and second geometric patterns have substantially the same shape.

9. The reference device of claim 8, wherein said first and second geometric patterns have a shape selected from the group consisting of:
a. substantially circular; and
b. substantially polygonal.

10. The reference device of claim 1, wherein said attachment mechanism comprises a clip body comprising a first frame support and a second frame support, wherein said first and second frame supports are configured to cooperate to maintain said reference device adjacent said eyewear frame when said reference device is attached to said eyewear frame.

11. The reference device of claim 10, wherein said attachment mechanism further comprises a clip horizontal slider comprising a third frame support and a fourth frame support, wherein said clip horizontal slider is configured to enable a user to:
a. slideably attach said clip horizontal slider to said clip body, and
b. slide relative to said clip body such said clip body and said clip horizontal slider is adjustable between a first length and a second length.

12. The reference device of claim 10, wherein said first frame support comprises a pitch adjustment mechanism configured to adjust a pitch of a portion of said reference device relative to said eyewear frame when said reference device is attached to said eyewear frame.

13. The reference device of claim 12 wherein said pitch adjustment mechanism comprises:
a. a threaded opening in said first frame support; and
b. a threaded screw that substantially corresponds in diameter to said threaded opening,
wherein said screw is configured to enable a user to adjust said pitch of said portion of said reference device by rotating said threaded screw within said threaded opening.

14. The reference device of claim 12, wherein said portion of said reference device is a substantially planar surface that is configured to removeably receive said geometric pattern in an orientation that is substantially parallel to a front surface of lenses postioned in the eyewear.

15. The reference device of claim 10, wherein:
a. said clip body defines a substantially flat surface; and
b. said geometric pattern is disposed at least partially on said substantially flat surface,
wherein the flat surface is substantially parallel to a surface of a lens retained in the eyewear frame.

16. The reference device of claim 1, further comprising a mobile measurement device comprising at least one processor configured to:
a. capture an image of a user wearing the frames having said geometric pattern removeably coupled to the frames;
b. determine a second distance between the first and second geometric attributes in said geometric pattern from the captured image;
c. calculate a scale factor at least partially based on the determined second distance and the first distance;
d. determine a measurement of a facial characteristic from the captured image;
e. calculate an actual measurement of the facial characteristic at least partially based on the measurement of the facial characteristic from the captured image and the calculated scale factor.

17. A computer system for measuring facial characteristics of a person wearing eyewear, said computer system comprising at least one processor, wherein said computer system is configured to:
a. receive a first image comprising
i. a reference device having a geometric pattern attached thereon, wherein the reference device is attached to a pair of eyewear that is worn by a wearer, said geometric pattern comprising:
a first geometric attribute; and
a second geometric attribute that is spaced a known distance apart from said first geometric attribute; and
ii. at least a portion of a face of the wearer, said at least a portion of the face of the wearer comprising a first eye and a second eye of the wearer;
b. determine a distance between said first geometric attribute and said second geometric attribute from said image;
c. calculate, based at least in part on said known distance and said determined distance, a reference scale for said first image;
d. determine a measurement of a facial characteristic from said first image; and
e. using said reference scale and said measurement of said facial characteristic, calculate an actual measurement of said facial characteristic of the wearer in the first image.

18. The computer system of claim 17, wherein said facial characteristic is selected from a group consisting of:
a. a pupillary distance of the wearer in said first image; and
b. a vertex distance of the wearer in said first image.

19. The computer system of claim 17, wherein calculating said reference scale further comprises adjusting said reference scale to correct for errors that arise at least in part on an orientation of said geometric pattern with respect to an image sensor used to capture said first image.

20. The computer system of claim 18, wherein said calculating said reference scale further comprises adjusting said reference scale to correct for errors arise at least in part on distortion of said geometric pattern within said first image.

21. A method of measuring a facial characteristic of a patient comprises:
a. providing a reference device comprising:
i. a geometric pattern comprising:
a first geometric attribute; and
a second geometric attribute spaced a first distance apart from said first geometric attribute; and
ii. an attachment mechanism operatively coupled to said geometric pattern and configured to enable a user to selectively attach the reference device to eyewear;
b. attaching said reference device to eyewear;
c. placing said pair of eyewear and said reference device on a patient;
d. receiving, by at least one processor, an image comprising said reference device and at least a portion of said patient's face;
e. determining, by at least one processor, a measurement of a second distance between said first geometric attribute and said second geometric attribute from the received image;
f. calculating, by at least one processor, a reference scale for said image based at least in part on said first distance and said second distance;
g. using, by at least one processor, said reference scale to convert measurements of facial characteristics of the patient taken from said image into actual measurements of the patient's facial characteristics.

22. The method of claim 21, wherein said facial characteristic is selected from a group consisting of:
a. a pupillary distance of said patient; and
b. a vertex distance of said patient.
